(19) United States
(12) Patent Application Publication
(10) Pub. No.: US 2019/0172294 A1
(43) Pub. Date: Jun. 6, 2019

(54) parallel light grating device

(71) Applicants: Ti Chin Chang, Tainan City (TW); Tong Tsan Chien, Tainan City (TW); Chia Ling Hsieh, Tainan City (TW); Yao Ling Chang, Tainan City (TW)

(72) Inventors: Ti Chin Chang, Tainan City (TW); Tong Tsan Chien, Tainan City (TW); Chia Ling Hsieh, Tainan City (TW); Yao Ling Chang, Tainan City (TW)

(21) Appl. No.: 16/260,131

(22) Filed: Jan. 29, 2019

(30) Foreign Application Priority Data
Jun. 1, 2018 (TW) 107207381

(51) Int. Cl. G07F 9/02; G02B 27/44; G02B 27/42; G01V 8/20

(52) U.S. Cl. CPC G07F 9/026; G01V 8/20; G02B 27/4233; G02B 27/44

(57) ABSTRACT

A parallel light grating device includes emitters each for emitting a radiation for detecting a presence of an item, detectors each for receiving the radiation from one emitter so as to determine whether an item has passed a path of the radiation or not, and lenses. The lenses are disposed between the emitters and the detectors. The emitters, the detectors, and the lenses are disposed in a corresponding relationship. The diffracted radiation is collimated by the lenses to form a grating. A distance between any two adjacent ones of the detectors is less than a length of a longitudinal section of the item. The detectors are capable of detecting the passing of the item using the grating.

### BACKGROUND OF THE INVENTION

### 1. Field of the Invention

The invention relates to grating devices and more particularly to a parallel light grating device.

### 2. Description of Related Art

A conventional grating device 1 is shown in FIGS. 1, 2 and 3. The grating device 1 is provided adjacent to an open compartment of a vending machine for sensing whether an item 2 falls into the compartment or not.

In FIG. 1, the grating device 1 comprises a plurality of emitters 11 at one end and a plurality of detectors 12 at the other end for receiving radiation A transmitted from the emitters 11. When an item enters the path of the radiation A, the absence of the radiation A being received at the detectors 12 provides an indication that there is an item 2 in the path of the beam (i.e., the item 2 falling into the compartment). Thereafter, the processor of the vending machine may process the signal to acknowledge that the item 2 has been released and replenishment is done so that a next vending operation is made possible. However, the conventional grating device 1 has the following disadvantages:

The detectors 12 may be not “fail-safe” reliable. As shown in FIG. 2, the radiation A may be partially blocked by the item 2 when the item 2 enters the path of the radiation A (i.e., the path from the emitters 11 to the detectors 12). However, the radiation A received by the detectors 12 is in the form of diffraction because the radiation A emitted by the emitters 11 is diffracted. Thus, there are density differences in different portions of the radiation A between the emitters 11 and the detectors 12. As discussed above, a substantial portion of the radiation A is received by the detectors 12 since the radiation A is partially blocked by the item 2 when the item 2 enters the path of the radiation A. Therefore, the detectors 12 do not detect the falling of the item 2 into the compartment. Thereafter, the processor of the vending machine may not process a signal generated by the passing of the item 2. And in turn, it does not acknowledge that the item 2 has been released and replenishment is not done. As a result, a next vending operation is not performed.

The detectors 12 may still be not “fail-safe” reliable. As shown in FIG. 3, the radiation A may be partially blocked by a very small item 2′ when the item 2′ enters the path of the radiation A. However, the detectors 12 may not detect the item 2′ due to its small size. A substantial portion of the radiation A is still received by the detectors 12. Thereafter, the processor of the vending machine may not process a signal generated by the passing of the item 2′. And in turn, it does not acknowledge that the item 2′ has been released and replenishment is not done. As a result, a next vending operation is not performed.

The “fail-safe” reliability of the detectors 12 is very low due to low precision.

For solving above problems, the detectors 12 are improved by determining whether an item has passed the path of the radiation or not based on the strength of the radiation A or characteristics of the radiation A (e.g., direction change, frequency change, settings, etc.) However, the “fail-safe” reliability of the detectors 12 is still very low. This is because it is very difficult of controlling the strength of the radiation A and the conventional logic design has a low precision. Thus, it is impossible of determining whether any item has passed the path of the radiation.

Thus, the need for improvement still exists.

### SUMMARY OF THE INVENTION

It is therefore one object of the invention to provide a parallel light grating device including a plurality of lenses between the emitters and the detectors so as to provide a “fail-safe” reliability for the detection of an item in the path of radiation emitted from the emitter to the detector.

For achieving above and other objects, the invention provides a parallel light grating device comprising a plurality of emitters each for emitting a radiation for detecting a presence of an item, a plurality of detectors each for receiving the radiation from the corresponding one of the emitters so as to determine whether an item has passed a path of the radiation or not, and a plurality of lenses wherein the lenses are disposed between the emitters and the detectors; the emitters, the detectors, and the lenses are disposed in a corresponding relationship; the radiation from each emitter is diffracted; the diffracted radiation is collimated by the lenses to form a grating; a distance between any two adjacent ones of the detectors is less than a length of a longitudinal section of the item; and the detectors are capable of detecting the passing of the item using the grating.

Preferably, the lenses are Fresnel lenses, each emitter is located at a focus of the Fresnel lens, and the Fresnel lens is configured to collimate the radiation emitted from the emitter.

Preferably, the emitters are LEDs (light-emitting diodes).

Preferably, the diffracted radiation is collimated by the Fresnel lenses to form a grating, and the detectors are capable of detecting the passing of the item using the grating.

The invention has the following advantages and benefits in comparison with the conventional art: the radiation received by the detector is collimated. Thus, the detectors detect the presence of the item in the path of radiation (i.e., the grating) and light from other directions is not received by the corresponding detectors. The detectors provide an indication that there is an item in the grating. Thereafter, the processor of the vending machine may process the signal to acknowledge that the item has been released and replenishment is done so that a next vending operation is made. This can eliminate the drawbacks of the conventional art which allows light from other directions to enter the path of radiation and in turn causes the detectors to receive same, thereby failing to detect the falling of the item.

By utilizing the invention, the radiation from each emitter is collimated by the lens (e.g., Fresnel lens) prior to be received by the corresponding detector. Further, the detectors detect the presence of the item in the path of radiation (i.e., the grating). As a result, the detectors determine whether there is an item in the grating.

In applications, the parallel light grating device of the invention is disposed at an empty compartment of a vending machine, a security door, or any one of security sensitive areas. The parallel light grating device can detect the presence of an item, a person, or the like. Once detected, time, date and the number of the items or the persons are recorded.

The above and other objects, features and advantages of the invention will become apparent from the following detailed description taken with the accompanying drawings.

### BRIEF DESCRIPTION OF THE DRAWINGS

FIG. 1 schematically depicts operation of a conventional grating device;

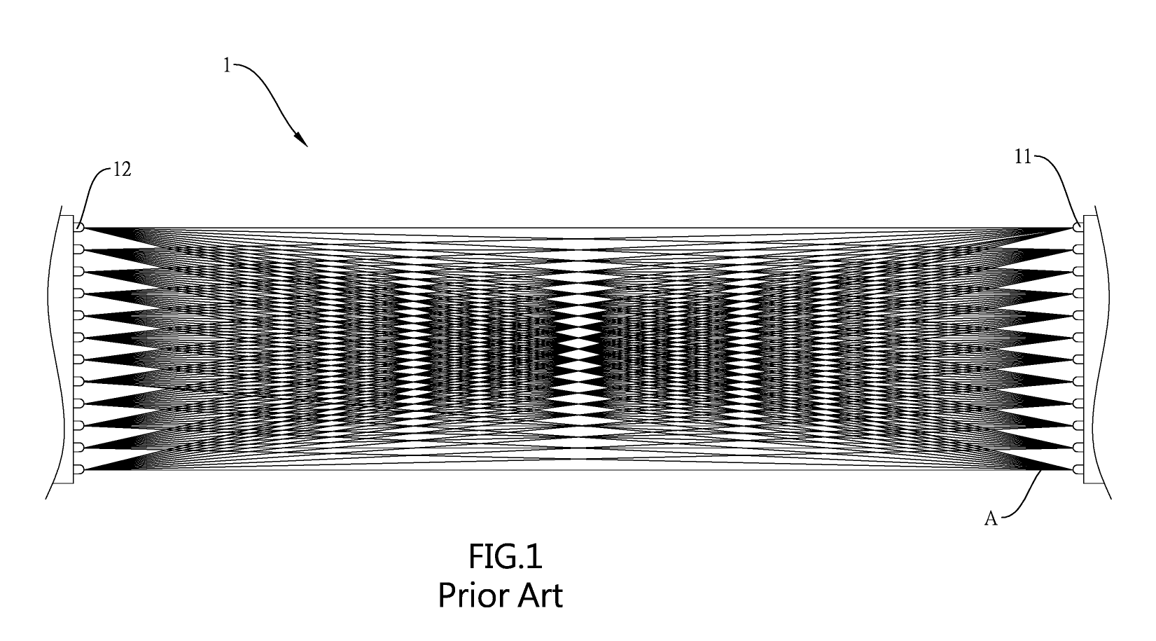

FIG. 2 schematically depicts an item detection of the conventional grating device;

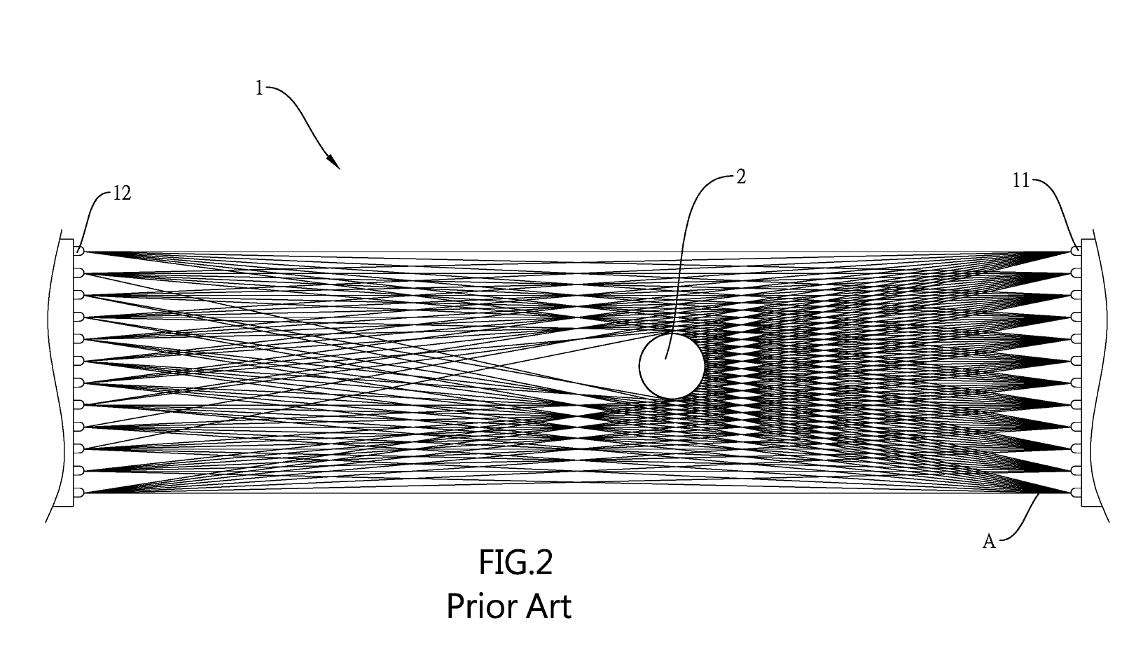

FIG. 3 schematically depicts another item detection of the conventional grating device;

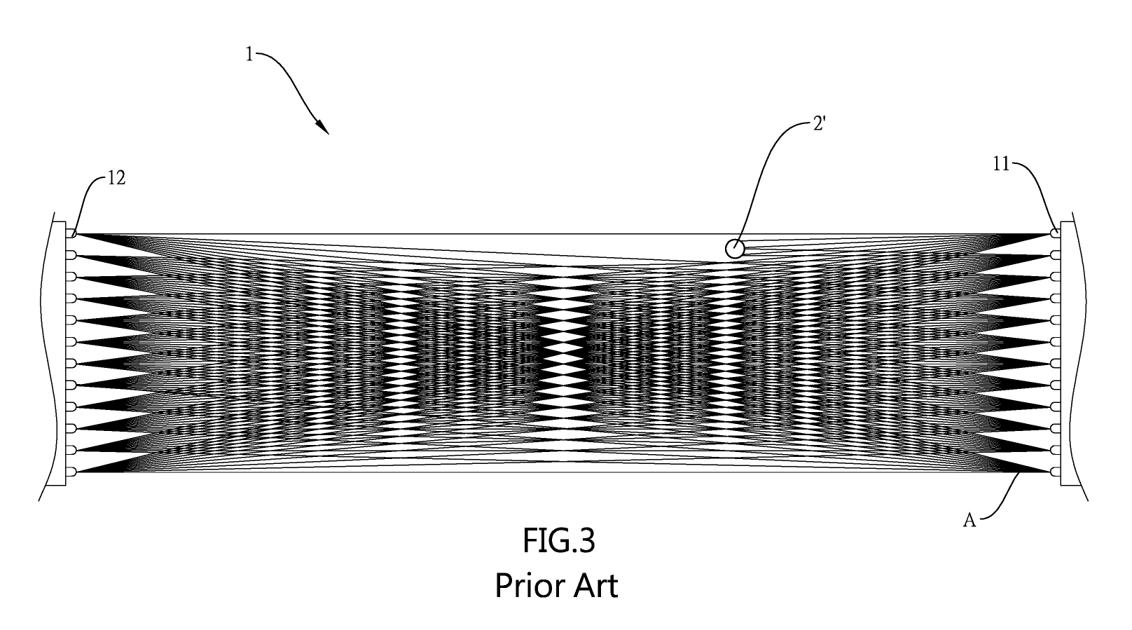

FIG. 4 schematically depicts operation of a parallel light grating device according to the invention;

FIG. 5 is a detailed view of the area in a circle of FIG. 4; and

FIG. 6 schematically depicts an item detection of the parallel light grating device.

### DETAILED DESCRIPTION OF THE INVENTION

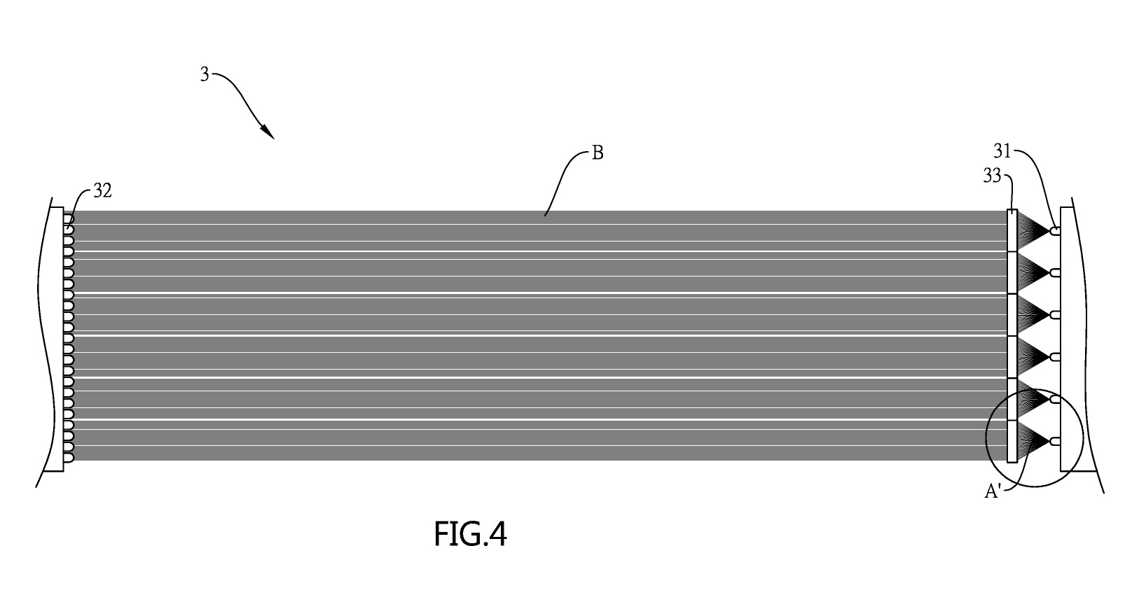

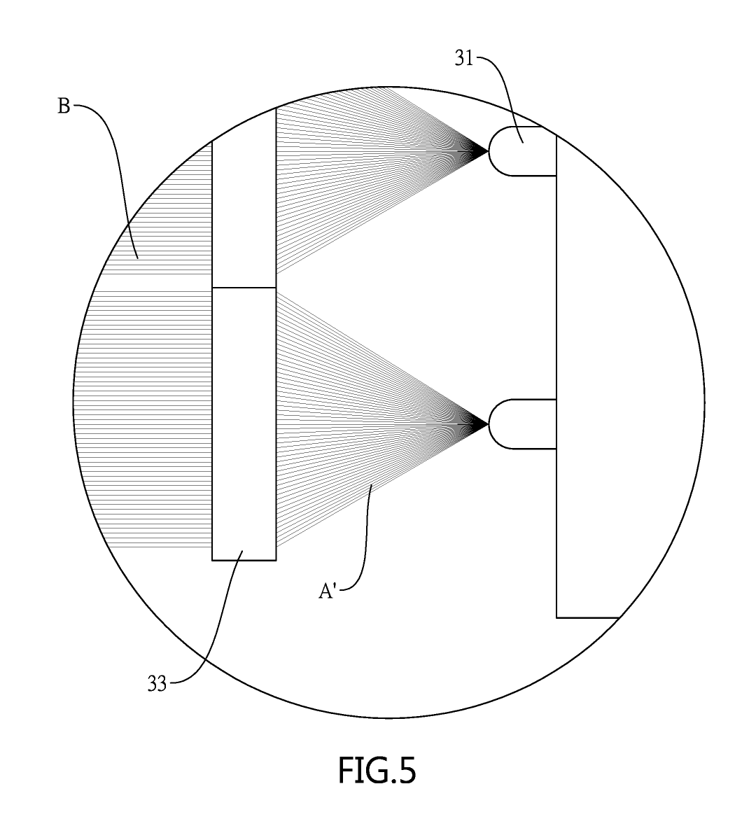

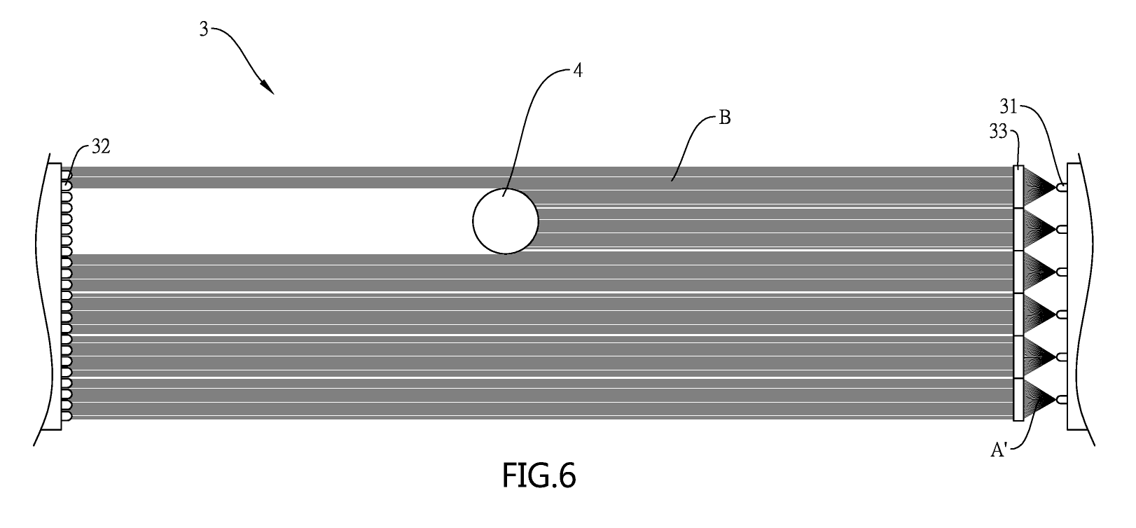

Referring to FIGS. 4 to 6, a parallel light grating device 3 in accordance with the invention comprises a plurality of emitters 31, a plurality of detectors 32 and a plurality of lenses 33.

Each emitter 31 is configured to emit a radiation A′ for detecting the passing of an item 4. The emitters 31 are implemented by LEDs (light-emitting diodes).

Each detector 32 is configured to receive the radiation A′ for determining whether the item 4 has passed the path of the radiation A′ or not.

Characteristics of the invention are as discussed in detail below. The plurality of lenses 33 are provided between the emitters 31 and the detectors 32. The emitters 31, the detectors 32 and the lenses 33 are disposed in a corresponding relationship. The diffracted radiation A′ is collimated by the lenses 33 to become a beam of parallel rays (i.e., collimated beam of light) prior to directing toward the detectors 32. The collimated beam of light is in the form of grating B. The distance between any two adjacent detectors 32 is less than a length of a longitudinal section of the item 4. Therefore, the detectors 32 are capable of detecting the passing of the item 4 using the grating B.

Preferably, the lenses 33 are Fresnel lenses, and the emitter 31 is located at the focus of the Fresnel lens. The Fresnel lens 33 may collimate the radiation A′ emitted from the emitter 31 to form a plurality of parallel rays of light which are in turn directed toward the corresponding detector 32 in the form of grating B. As an end, the detector 32 may be aware of the presence of the item 4 by detecting the grating B.

In applications, the parallel light grating device 3 of the invention is disposed at an empty compartment of a vending machine, a security door, or any one of security sensitive areas. Thus, the parallel light grating device 3 can detect the presence of an item, a person, or the like. Once detected, time, date and the number of the items or the persons are recorded.

The following exemplary example of the invention is described in terms of the lenses 33 are Fresnel lenses and the parallel light grating device 3 of the invention is disposed at an empty compartment of a vending machine.

First, radiation A′ is emitted from each emitter 31 in the form of point light source (e.g., LED) and in the form of diffraction. Further, the radiation A′ is directed toward the corresponding detector 32. Each emitter 31 is located at the focus of the Fresnel lens.

The diffracted radiation A′ may pass the Fresnel lens to make parallel, i.e., parallel rays of light, prior to directing toward the detector 32. The collimated beam of light is in the form of grating B. Therefore, the detectors 32 are capable of detecting the passing of the item 4 using the grating B.

Subsequently, the collimated beam of light is received by the detector 32 and light from other directions is not received by the detector 32. Thus, light from other directions does not interfere with the determination of whether the item 4 is in the path of radiation. This greatly increases accuracy. As a result, a “fail-safe” reliability is provided by the invention and a dispensing operation of the vending machine is highly precise.

In a normal operation of the vending machine, the radiation A′ from the emitter 31 is collimated and the detector 32 receives the collimated beam of light which is in the form of grating B. After a person selected an item 4 and made the payment, the item 4 may fall from the rack into an empty compartment. The falling item 4 may be in the path of radiation between the Fresnel lenses 33 and the detectors 32. Thus, the collimated beam of light (i.e., the grating B) is partially blocked by the item 4. And in turn, the corresponding detectors 32 may not receive the grating B and light from other directions is not received by the corresponding detectors 32. Thus, the detectors 32 provide an indication that there is an item 4 in the path of the radiation. Thereafter, the processor of the vending machine may process the signal to acknowledge that the item 4 has been released and replenishment is done so that a next vending operation is made possible.

It is envisaged by the invention that with the provision of a plurality of lenses (e.g., Fresnel lenses) 33 between the emitters 31 and the detectors 32, collimated beam of light (i.e., the grating B) can be received by the detectors 32. Further, size of the item 4 is greater than a distance between any two adjacent detectors 32. Thus, the detectors 32 can detect the presence of the item 4 in the path of radiation (i.e., the grating B) and light from other directions is not received by the corresponding detectors 32. The detectors 32 provide an indication that there is an item 4 in the grating B. Thereafter, the processor of the vending machine may process the signal to acknowledge that the item 4 has been released and replenishment is done so that a next vending operation is made. This can eliminate the drawbacks of the conventional art which allows light from other directions to enter the path of radiation and in turn causes the detectors 32 to receive same, thereby failing to detect the falling of the item 4.

The parallel light grating device of the invention has the following advantages and benefits in comparison with the conventional art:

A “fail-safe” reliability is provided: the corresponding detectors may receive the grating and light from other directions is not received by the corresponding detectors. Thus, the detectors provide an indication that there is an item in the path of the radiation. Thereafter, the processor of the vending machine may process the signal to acknowledge that the item has been released and replenishment is done so that a next vending operation is made possible. This eliminates the drawbacks of the conventional art which allows light from other directions to enter the path of radiation and in turn causes the detectors to receive same, thereby failing to detect the falling of the item.

The “fail-safe” reliability is provided by simple components: the provision of the lenses collimates the diffracted light from the emitters. Light from other directions is not received by the corresponding detectors. Thus, the detectors provide an indication that there is an item in the path of the radiation. No complicated mechanism is involved.

While the invention has been described in terms of preferred embodiments, those skilled in the art will recognize that the invention can be practiced with modifications within the spirit and scope of the appended claims.

What is claimed is:

1. A parallel light grating device comprising a plurality of emitters each for emitting a radiation for detecting a presence of an item, a plurality of detectors each for receiving the radiation from one of the emitters so as to determine whether an item has passed a path of the radiation or not, and a plurality of lenses wherein:
the lenses are disposed between the emitters and the detectors;
the emitters, the detectors, and the lenses are disposed in a corresponding relationship;
the radiation from each emitter is diffracted;
the diffracted radiation is collimated by the lenses to form a grating;
a distance between any two adjacent ones of the detectors is less than a length of a longitudinal section of the item; and
the detectors are capable of detecting the passing of the item using the grating.

2. The parallel light grating device of claim 1, wherein the lenses are Fresnel lenses, each emitter is located at a focus of the Fresnel lens, and the Fresnel lens is configured to collimate the radiation emitted from the emitter.

3. The parallel light grating device of claim 1, wherein the parallel light grating device is located at an item exit of a vending machine.

4. The parallel light grating device of claim 1, wherein the emitters are LEDs (light emitting diodes).
